(19) United States
(12) Patent Application Publication
(10) Pub. No.: US 2025/0239788 A1
(43) Pub. Date: Jul. 24, 2025

(54) TOGGLE BUTTON STRUCTURE AND QUICK WIRING MECHANISM

(71) Applicant: ZHEJIANG ELE MFG. CO., LTD, Zhejiang (CN)

(72) Inventors: Mingliang HU, Zhejiang (CN); Zhiping ZHOU, Zhejiang (CN)

(21) Appl. No.: 19/035,056

(22) Filed: Jan. 23, 2025

(30) Foreign Application Priority Data
Jan. 24, 2024 (CN) 2024101017639
Nov. 19, 2024 (CN) 2024228256821

(51) Int. Cl. H01R 4/48

(52) U.S. Cl. CPC H01R 4/48

(57) ABSTRACT

The present application discloses a toggle button structure and a quick wiring mechanism, the toggle button structure comprising: a housing, wherein the housing is provided with a toggle lever moving hole, an inner side wall of the toggle lever moving hole is provided with a first protrusion; a toggle lever, wherein the toggle lever extends into an inner cavity of the housing through the toggle lever moving hole, a bottom end of the toggle lever is rotatably connected with the inner cavity of the housing, and a top end of the toggle lever protrudes from the toggle lever moving hole; a button, wherein the button is slidably arranged inside the toggle lever by means of an elastic component, a side wall of the button is provided with a second protrusion, the second protrusion protrudes from a side wall of the toggle lever and can slide inside the toggle lever along with the button. When the button is not pressed, the second protrusion and the first protrusion are oppositely abutting against each other to prevent the toggle lever from swinging toward a side close to the first protrusion effectively, thereby increasing the overall stability of the structure, and preventing occurrence of the toggle lever being pushed accidentally which would result in incorrect operation. And by means of the cooperation of the first protrusion and the second protrusion, the stability of the toggle lever at the specific position is ensured and the operation accuracy is improved.

### CROSS REFERENCE TO RELATED APPLICATIONS

The present application claims the priority of the Chinese patent application with the application number of 202410101763.9, filed with the CNIPA on Jan. 24, 2024 and entitled “Quick wiring mechanism”, and claims the priority of the Chinese patent application with the application number of 202422825682.1, filed with the CNIPA on Nov. 19, 2024, entitled “Toggle button structure and quick wiring mechanism”, the disclosures of which are incorporated herein by reference in their entireties.

### TECHNICAL FIELD

The present application relates to the technical field of wiring devices, in particular relates to a toggle button structure and a quick wiring mechanism.

### BACKGROUND

The content provided by this section is only background information that relates to the present disclosure, and does not necessarily constitute prior art.

At present, when a wire is inserted into a socket, the wire needs to be locked by a screw, and wiring needs to be performed by specialized tools and professionals. During the specific wiring process, a wire is inserted between a screw and a socket sheet, and then a specialized electrical screwdriver is used to fasten the screw, and the screws can be fastened only when the torque force reaches a required value, resulting in inconvenience of users, slow wiring, waste of time and manpower, and low efficiency.

In order to solve the above technical problem, the applicant has previously filed a utility model patent application that was granted with the publication number of CN221596768U, wherein, when performing a wiring operation, an operator only needs to drive a toggle structure to achieve fastening of wires. The mechanism shall be operated according to specific operation requirements when performing wiring and pulling out wires, wherein, after a wire is inserted into the reserved space, the operator needs to press the button to disengage the snap-fit and then push the toggle lever to rotate, so as to fasten the wire. And, after a wire is inserted into the reserved space, in the case of the button having not been pressed by a user, if the user pushes the toggle lever incorrectly, because the hook of the toggle lever is in a positioning state of being hooked with the hook positioning part, when the toggle lever is pushed forcibly, it would result in the hook on the button being forcibly disengaged from the hook positioning part on the housing, and this would easily cause the hook and/or the hook positioning part to be damaged.

### SUMMARY OF THE APPLICATION

Therefore, an objective of the present application is to provide a toggle button structure and a quick wiring mechanism to overcome the defect that a snap-fit structure would be damaged when a user operates a wiring mechanism incorrectly.

Another objective of the present application is to provide a quick wiring mechanism to overcome the defects in the prior art that a specialized tool needs to be used for wiring, which leads to inconvenient operation, being time-consuming and laborious, and being inefficient.

In order to achieve the above objectives, the present application adopts the following technical solutions:

In one aspect, the present application provides a toggle button structure that includes:
a housing, wherein the housing is provided with a toggle lever moving hole, an inner side wall of the toggle lever moving hole is provided with a first protrusion;
a toggle lever, wherein the toggle lever extends into an inner cavity of the housing through the toggle lever moving hole, a bottom end of the toggle lever is rotatably connected with the inner cavity of the housing, and a top end of the toggle lever protrudes from the toggle lever moving hole;
a button, wherein the button is slidably arranged inside the toggle lever by means of an elastic component, a side wall of the button is provided with a second protrusion, the second protrusion protrudes from a side wall of the toggle lever and can slide inside the toggle lever along with the button;
when the button is not pressed, the second protrusion and the first protrusion are oppositely abutting against each other to prevent the toggle lever from swinging toward a side close to the first protrusion; when the button is pressed, the second protrusion moves to a position below the first protrusion and becomes staggered with the first protrusion to enable the toggle lever to swing toward the side close to the first protrusion.

As an optional implementing way, the side wall of the toggle lever facing the first protrusion is provided with a second protrusion sliding hole, the second protrusion passes through the second protrusion sliding hole and can slid along the second protrusion sliding hole.

As an optional implementing way, the side wall of the button facing the first protrusion is provided with a first protrusion accommodating groove, the first protrusion accommodating groove is located above the second protrusion;
when the button is pressed to enable the toggle lever to swing toward the side close to the first protrusion, the first protrusion passes through the second protrusion sliding hole and becomes accommodated in the first protrusion accommodating groove.

As an optional implementing way, the first protrusion is provided with a first-protrusion upper end surface, a first-protrusion lower end surface and a first-protrusion side surface, the first-protrusion side surface is a surface of the first protrusion facing the second protrusion;
the second protrusion is provided with a second-protrusion upper end surface, a second-protrusion lower end surface, and a second-protrusion side surface, the second-protrusion side surface is a surface of the second protrusion facing the first protrusion;
the first protrusion accommodating groove is provided with an accommodating-groove first end surface, an accommodating-groove second end surface and an accommodating-groove third end surface connected in sequence, the second-protrusion upper end surface is arranged to be coplanar with the accommodating-groove first end surface;
an angle between the accommodating-groove first end surface and the accommodating-groove second end surface is equal to an angle between the first-protrusion lower end surface and the first-protrusion side surface, so as to enable the first protrusion to match the first protrusion accommodating groove.

As an optional implementing way, an angle between the accommodating-groove second end surface and the accommodating-groove third end surface is larger than an angle between the first-protrusion upper end surface and the first-protrusion side surface, so that when the first protrusion is accommodated in the first protrusion accommodating groove, there is a distance between the accommodating-groove third end surface and the first-protrusion upper end surface.

As an optional implementing way, the first-protrusion side surface and the second-protrusion side surface are both vertical.

As an optional implementing way, the first-protrusion lower end surface is a sloping surface gradually sloping downward from an end close to the second protrusion to an end away from the second protrusion.

As an optional implementing way, a side wall of the button is provided with an elongated hole, a direction of the major axis of the elongated hole is the same as a movement direction of the button in the toggle lever; a position-limiting column is arranged inside the toggle lever, the position-limiting column passes through the elongated hole and is configured to limit a moving stroke of the button.

In another aspect, the present application further provides a quick wiring mechanism that includes:
the aforementioned toggle button structure, wherein the housing of the toggle button structure is provided with a wire inserting hole configured for a wire to be inserted therein;
an elastic wire clamping structure, which is arranged on the housing and has an unlocked state and a locked state; wherein, when the elastic wire clamping structure is in the unlocked state, the elastic wire clamping structure provides a reserved space for the wire, the reserved space is configured to enable the wire to be inserted into the housing through the wire inserting hole; when the elastic wire clamping structure is in the locked state, the elastic wire clamping structure is configured to press the wire that has been inserted into the housing to fasten the wire;
a part of the toggle lever of the toggle button structure arranged inside the housing abuts against the elastic wire clamping structure, the toggle lever is configured to control the elastic wire clamping structure to switch between the unlocked state and the locked state.

As an optional implementing way, the elastic wire clamping structure includes:
an inserted sheet terminal, arranged inside the housing;
an elastic-sheet-type wire clamping terminal, which is formed by bending and has elasticity, wherein one end of the elastic-sheet-type wire clamping terminal is fixed on the inserted sheet terminal, the other end of the elastic-sheet-type wire clamping terminal is configured to fasten the wire; the elastic-sheet-type wire clamping terminal has an unlocked state in which the wire can be inserted and a locked state in which the wire is fastened; when the elastic-sheet-type wire clamping terminal is in the unlocked state, the second protrusion and the first protrusion are oppositely abutting against each other, and the elastic-sheet-type wire clamping terminal is pressed by the toggle lever; when the elastic-sheet-type wire clamping terminal is in the locked state, the toggle lever swings to a side away from the elastic-sheet-type wire clamping terminal, and the second protrusion moves to a position below the first protrusion and becomes staggered with the first protrusion.

As an optional implementing way, the elastic-sheet-type wire clamping terminal includes:
a positioning segment, connected with the inserted sheet terminal;
a press segment, connected with the positioning segment and forming an unclosed press ring together with the positioning segment, wherein one side of the press ring away from the positioning segment abuts against a side wall of the toggle lever, and the press ring has an expanded configuration in an expanded state and a compressed configuration in a compressed state;
a clamping segment, connected with the press segment and having a hook shape.

In another aspect, the present application provides a quick wiring mechanism that includes:
a housing, provided with at least one wire inserting hole configured for a wire to be inserted therein;
at least one elastic wire clamping structure, which is arranged on the housing and has an unlocked state and a locked state; wherein, when the elastic wire clamping structure is in the unlocked state, the elastic wire clamping structure provides a reserved space for the wire, the reserved space is configured to enable the wire to be inserted into the housing through the wire inserting hole; when the elastic wire clamping structure is in the locked state, the elastic wire clamping structure is configured to press the wire that has been inserted into the housing to fasten the wire;
a toggle structure, wherein a part of the toggle structure is arranged inside the housing and configured to abut against the elastic wire clamping structure, another part of the toggle structure protrudes from the housing, the toggle structure is configured to control the elastic wire clamping structure to switch between the unlocked state and the locked state.

As an optional implementing way, the housing is provided with:
at least one toggle lever moving hole, configured to enable a top part of the toggle structure to protrude from the housing;
at least one toggle lever positioning part, configured to position a bottom end of the toggle structure;
at least one hook positioning part, configured to be engaged with or be disengaged from the toggle structure, so as to control the elastic wire clamping structure to be in the unlocked state or in the locked state.

As an optional implementing way, the toggle structure includes:
a toggle lever, wherein a bottom end of the toggle lever is rotatably connected to the toggle lever positioning part, a top end of the toggle lever protrudes from the toggle lever moving hole; an outer diameter of the toggle lever is smaller than an inner diameter of the toggle lever moving hole;
an engaging member, which is arranged on the toggle lever and has an engaged state of being engaged with the hook positioning part and a disengaged state of being disengaged from the hook positioning part.

As an optional implementing way, the elastic wire clamping structure includes:
an inserted sheet terminal, arranged inside the housing;
an elastic-sheet-type wire clamping terminal, which is formed by bending and has elasticity, wherein one end of the elastic-sheet-type wire clamping terminal is fixed on the inserted sheet terminal, the other end of the elastic-sheet-type wire clamping terminal is configured to fasten the wire; the elastic-sheet-type wire clamping terminal has an unlocked state in which the wire can be inserted and a locked state in which the wire is fastened; when the elastic-sheet-type wire clamping terminal is in the unlocked state, the engaging member is in the engaged state, and the elastic-sheet-type wire clamping terminal is pressed by the toggle lever; when the elastic-sheet-type wire clamping terminal is in the locked state, the engaging member is in the disengaged state, and the toggle lever is rotated to a side away from the inserted sheet terminal.

As an optional implementing way, the elastic-sheet-type wire clamping terminal includes:
a positioning segment, connected with the inserted sheet terminal;
a press segment, connected with the positioning segment and forming an unclosed press ring together with the positioning segment, wherein one side of the press ring away from the positioning segment abuts against a side wall of the toggle lever, and the press ring has an expanded configuration in an expanded state and a compressed configuration in a compressed state;
a clamping segment, connected with the press segment and having a hook shape.

As an optional implementing way, the toggle lever includes:
a toggle lever rotating part, wherein a bottom end of the toggle lever rotating part is rotatably connected to the toggle lever positioning part; a side wall of the toggle lever rotating part abutting against the elastic-sheet-type wire clamping terminal is a sloping side wall that slopes from top to bottom in a direction away from the elastic-sheet-type wire clamping terminal;
a button positioning part, integrally connected with the toggle lever rotating part, and partially protruding from the toggle lever moving hole.

As an optional implementing way, an engaging-member accommodating cavity configured to position the engaging member is provided inside the button positioning part, and a side wall of the button positioning part is provided with a hook sliding hole communicated with the engaging-member accommodating cavity.

As an optional implementing way, the engaging member includes:
a button, arranged inside the engaging-member accommodating cavity, wherein a top end of the button protrudes from the button positioning part;
a spring positioning column, integrally arranged at a bottom end of the button at a distance from an inner bottom wall of the engaging-member accommodating cavity;
a spring, sleeved on the spring positioning column, wherein one end of the spring is fixed to a bottom wall of the button, and the other end of the spring is fixed to the inner bottom wall of the engaging-member accommodating cavity;
a hook, integrally connected with the button, and protruding from the button positioning part through the hook sliding hole, wherein the hook is configured to be engaged with the hook positioning part or be disengaged from the hook positioning part.

As an optional implementing way, a side wall of the button positioning part is further provided with a convex block sliding hole, the convex block sliding hole is arranged in an opposite side relative to the hook sliding hole; a convex block configured to slide in the convex block sliding hole is integrally connected to the button; and a convex block abutting part configured to provide an abutting position for the convex block is arranged inside the housing.

As an optional implementing way, a side wall of the inserted sheet terminal is provided with at least one convex rib configured for clamping the wire, and the convex rib has a barb shape.

The technical solutions of the present application have the following advantages:

1. In the toggle button structure provided by the present application, when the button is not pressed, the second protrusion and the first protrusion are oppositely abutting against each other to effectively prevent the toggle lever from swinging toward a side close to the first protrusion, thereby increasing the overall stability of the structure, and preventing occurrence of the toggle lever being pushed accidentally which would result in incorrect operation. And by means of the cooperation of the second protrusion and the first protrusion, the stability of the toggle lever at the specific position is ensured and the operation accuracy is improved.
when the button is pressed, the second protrusion moves to a position below the first protrusion and becomes staggered with the first protrusion to achieve the swinging of the toggle lever easily, thereby improving the user experience.

2. In the toggle button structure provided by the present application, the side wall of the button facing the first protrusion is provided with a first protrusion accommodating groove, the first protrusion accommodating groove is located above the second protrusion. When the button is pressed, the first protrusion passes through the second protrusion sliding hole and enters the first protrusion accommodating groove, so that a reliable interlocking mechanism is formed to ensure that the toggle lever remains stable at a required position and will not be loosened due to external force or vibration. And after the first protrusion becomes accommodated in the first protrusion accommodating groove, the elastic component exerts an upward press force on the button to generate a press force between the second protrusion and the first protrusion, thereby enhancing the interlocking between the second protrusion and the first protrusion.

3. In the toggle button structure provided by the present application, an angle between the accommodating-groove first end surface and the accommodating-groove second end surface is equal to an angle between the first-protrusion lower end surface and the first-protrusion side surface, so as to enable the first protrusion to smoothly enter and become embedded in the first protrusion accommodating groove firmly, while preventing any gap or misalignment. A tight engagement is formed between the first protrusion and the first protrusion accommodating groove by the precise geometric matching, thereby improving the reliability and stability of the locking.

4. In the toggle button structure provided by the present application, an angle between the accommodating-groove second end surface and the accommodating-groove third end surface is larger than an angle between the first-protrusion upper end surface and the first-protrusion side surface, so that when the first protrusion is accommodated in the first protrusion accommodating groove, there is a distance between the accommodating-groove third end surface and the first-protrusion upper end surface, such that when a user presses the button to make the second-protrusion upper end face and the first-protrusion lower end face no longer squeezed against each other, the toggle lever can be easily pushed at this time, thereby reducing the resistance of operating.

5. In the toggle button structure provided by the present application, the first-protrusion side surface and the second-protrusion side surface are both vertical. The design of the vertical surfaces makes the first protrusion and the second protrusion more stable when they are in contact with each other, thereby reducing instability factors caused by a sloping contact surface. The vertical surfaces ensure that contact force is evenly distributed on the contact surface, thereby avoiding any wear or deformation of the first protrusion and/or second protrusion caused by excessive local pressure.

6. In the toggle button structure provided by the present application, the first-protrusion lower end surface is a sloping surface gradually sloping downward from an end close to the second protrusion to an end away from the second protrusion. The design of the sloping lower surface makes the first protrusion able to be guided smoothly when the first protrusion enters the first protrusion accommodating groove, thereby reducing the resistance of inserting, so that it can be operated more smoothly.

7. In the toggle button structure provided by the present application, a side wall of the button is provided with an elongated hole, a direction of the major axis of the elongated hole is the same as a movement direction of the button in the toggle lever, a position-limiting column is arranged inside the toggle lever, the position-limiting column passes through the elongated hole, and the position-limiting column is configured to limit a moving stroke of the button to ensure that the button can only move within a predetermined track, thereby preventing the button from being deviated or stuck during operation. The design of the position-limiting column and the elongated hole makes the button more stable when moving, thus reducing factors of shaking and instability, and improving the reliability and consistency of the operation.

8. In the quick wiring mechanism provided by the present application, the operating state of the elastic wire clamping structure is controlled by the toggle lever protruding from the housing, so as to facilitate operation by an operator, and the elastic wire clamping structure is driven to move by the movement of the toggle lever, and a wire can be clamped by the elastic wire clamping structure, thus achieving the function of locking the wire. Compared with the conventional method of locking a wire with a screw, the present application does not need to use any wiring tool, an operator only needs to drive the toggle lever to achieve locking of the wire, and ordinary family personnel can perform wiring easily, and therefore the wiring efficiency is improved and labor is saved.

9. In the quick wiring mechanism provided by the present application, the operating state of the elastic wire clamping structure is controlled by the toggle structure protruding from the housing, so as to facilitate operation by an operator, and the elastic wire clamping structure is driven to move by the movement of the toggle structure, and a wire can be clamped by the elastic wire clamping structure, thus achieving the function of locking the wire. Compared with the conventional method of locking a wire with a screw, the present application does not need to use any wiring tool, an operator only needs to drive the toggle structure to achieve locking of the wire, and ordinary family personnel can perform wiring easily, and therefore the wiring efficiency is improved and labor is saved.

10. In the quick wiring mechanism provided by the present application, in the process of practical application, it is convenient for wiring by using the product, a wire is inserted into the elastic-sheet-type wire clamping terminal directly, and the wire become clamped after the button is pressed; and when the wire needs to be taken out, the toggle lever is pushed to be engaged with the bottom housing in a hooked manner, and then the elastic-sheet-type wire clamping terminal is unlocked, the wire can be taken out quickly, and the operation is very convenient.

11. In the quick wiring mechanism provided by the present application, a side wall of the inserted sheet terminal is provided with at least one convex rib, and the con vex rib has a barb shape, the purpose of the convex rib is to clamp the wire and further reinforce the function of locking the wire.

12. In the quick wiring mechanism provided by the present application, the elastic-sheet-type wire clamping terminal comprises a positioning segment, a press segment, and a clamping segment. The press segment is connected with the positioning segment and forming an unclosed press ring together with the positioning segment. When the toggle lever presses the press ring to the left side, the press ring will be compressed, and it is in a compressed configuration at this time, and the clamping segment will be pushed to move toward a side away from the positioning segment, so that the clamping segment will not fasten the wire. When the toggle lever swings toward the right side, the press ring will expand under elastic force, and it is in the expanded configuration at this time, so that the clamping segment will move toward a side close to the positioning segment, and the wire is fastened. It is very convenient to adopt the method of the present application to fasten the wire, as it only needs to control the state of the press ring.

13. In the quick wiring mechanism provided by the present application, a side wall of the toggle lever rotating part abutting against the elastic-sheet-type wire clamping terminal is a sloping side wall that slopes from top to bottom in a direction away from the elastic-sheet-type wire clamping terminal, so that when the toggle lever swings, the elastic wire clamping structure can be smoothly expanded to enable the clamping segment of the elastic wire clamping structure to move in a direction towards the wire, and thereby the wire is fastened.

14. In the quick wiring mechanism provided by the present application, by controlling the button that protrudes out of the housing, controlling of the engaged and disengaged state of the toggle structure is achieved, and thus the operating state of the elastic wire clamping structure is controlled, which is very convenient, and the operation is fast, and the purpose of quick wiring is achieved.

### BRIEF DESCRIPTION OF THE DRA WINGS

In order to more clearly explain technical solutions in specific embodiments of the present application or in the prior art, the accompanying drawings to be used in the description of the specific embodiments or the prior art will be briefly described below. Apparently, the accompanying drawings described below only represent some embodiments of the present application. For those ordinarily skilled in the art, other drawings may also be obtained based on these accompanying drawings without expenditure of creative efforts.

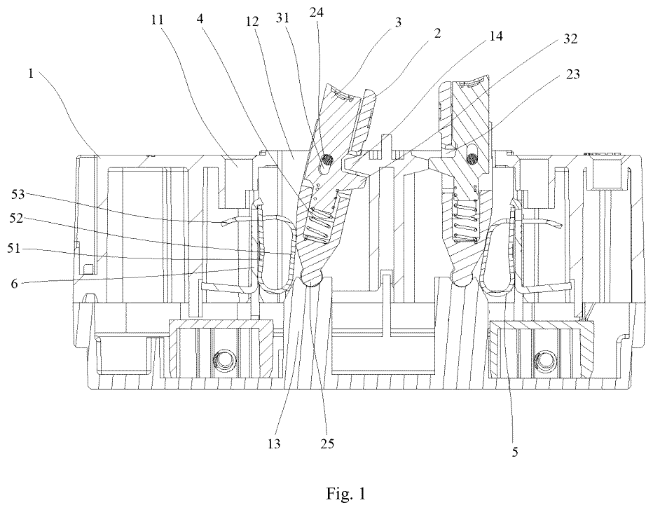

FIG. 1 is a cut-away view of the toggle button structure provided by the present application;

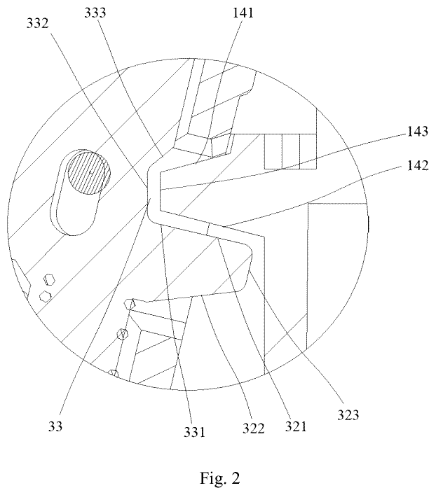

FIG. 2 is a partial cut-away view of the toggle button structure provided by the present application;

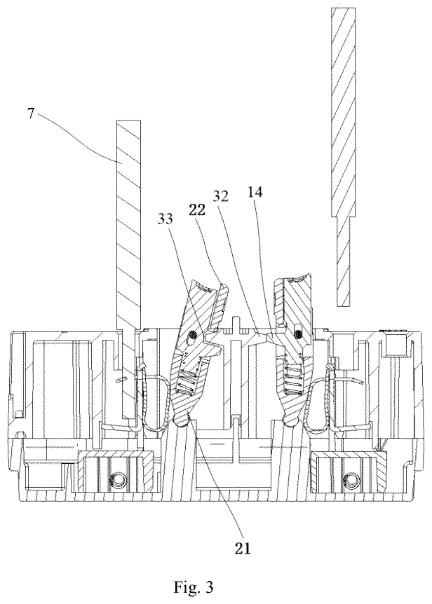

FIG. 3 is a cut-away view of the quick wiring mechanism provided by the present application when inserting or taking out a wire;

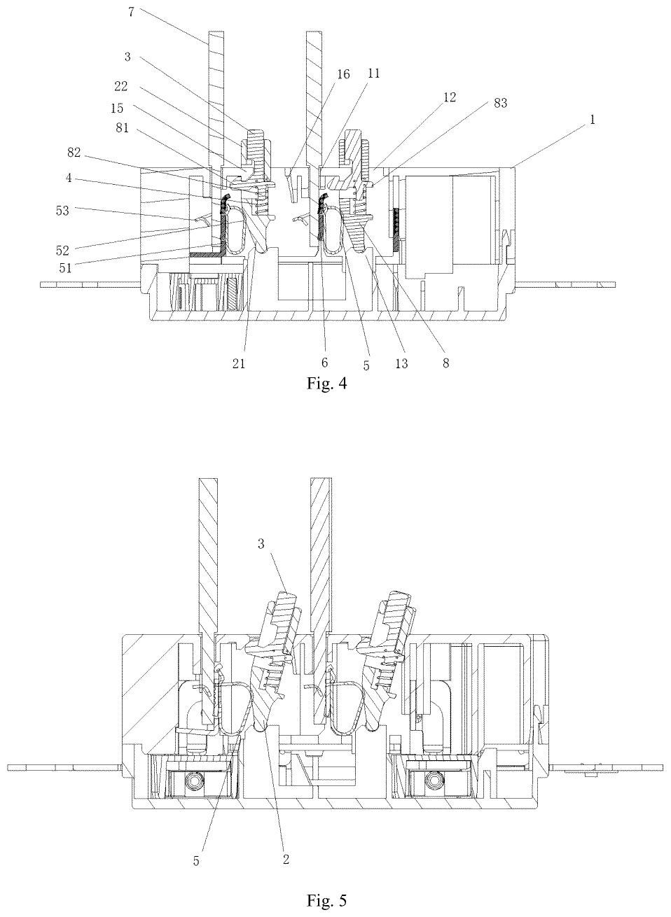

FIG. 4 is a cut-away view of the present application when a wire is inserted;

FIG. 5 is a cut-away view of the present application when a wire is fastened;

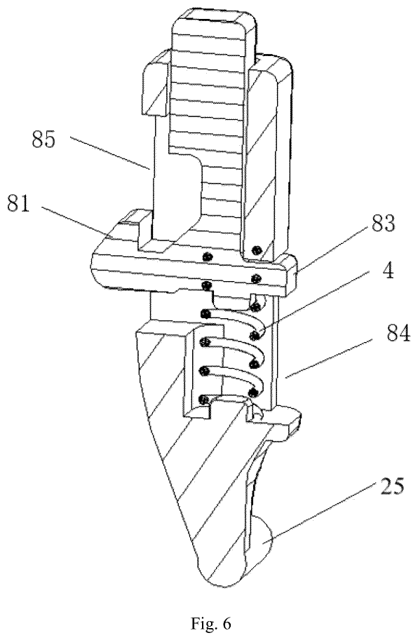

FIG. 6 is a cut-away view of the toggle structure in the present application;

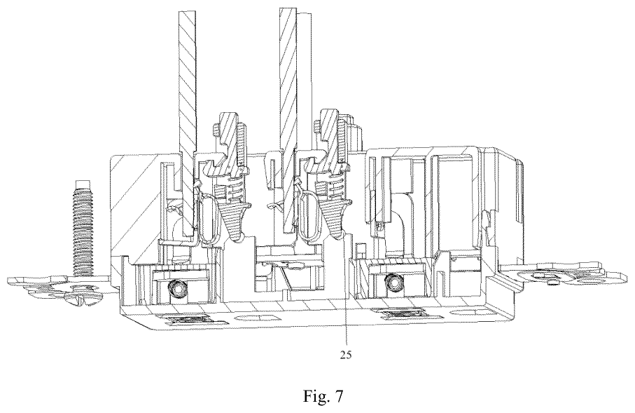

FIG. 7 is a partial cut-away view of the present application.

### REFERENCE NUMERALS

1. housing, 11. wire inserting hole, 12. toggle lever moving hole, 13. toggle lever positioning part, 14. first protrusion, 141. first-protrusion upper end surface, 142. first-protrusion lower end surface, 143. first-protrusion side surface, 15. hook positioning part, 16. convex block abutting part;
2. toggle lever, 21. toggle lever rotating part, 22. button positioning part, 23. second protrusion sliding hole, 24. position-limiting column, 25. shaft;
3. button, 31. elongated hole, 32. second protrusion, 321. second-protrusion upper end surface, 322. second-protrusion lower end surface, 323. second-protrusion side surface, 33. first protrusion accommodating groove, 331. accommodating-groove first end surface, 332. accommodating-groove second end surface, 333. accommodating-groove third end surface;
4. spring;
5. elastic-sheet-type wire clamping terminal, 51. positioning segment, 52. press segment, 53. clamping segment;
6. inserted sheet terminal;
7. wire;
8. toggle structure, 81. hook, 82. spring positioning column, 83. convex block, 84. convex block sliding hole, 85. hook sliding hole.

### DETAILED DESCRIPTION

Technical solutions of the present application will be clearly and completely described below in conjunction with the accompanying drawings. Apparently, the described embodiments only represent a part of the embodiments of the present application, not all of them. Based on the embodiments described in the present application, all other embodiments obtainable by those ordinarily skilled in the art without expenditure of creative labor fall within the scope of protection of the present application.

In the description of the present application, it should be noted that the orientation or position relations indicated by the terms “center”, “upper”, “lower”, “left”, “right”, “vertical”, “horizontal”, “inner”, “outer”, and the like are orientation or position relations illustrated based on the drawings, and are merely for the convenience of describing the present application and simplifying the description, and are not intended to indicate or imply the denoted device or element must have a specific orientation or must be constructed and operated in a specific orientation. Therefore, such terms should not be construed as limiting the present application.

In the description of the present application, it should be noted that, unless otherwise clearly specified and defined, the terms “installed”, “coupled” and “connected” should be understood in a broad sense, for example, it may indicate fixed connection, or detachable connection, or integral connection; it may indicate mechanical connection, or electrical connection; it may indicate direct connection, or indirect connection through an intermediate medium, or internal communication between two components. For a person with ordinary skill in the art, specific meanings of the above-mentioned terms in the present application may be construed according to specific circumstances thereof.

In addition, the technical features involved in different embodiments of the present application described below may be combined with each other so long as they do not conflict with each other.

### Embodiment 1

In conjunction with FIGS. 1 to 3, this embodiment discloses a toggle button structure, which includes a housing 1, a toggle lever 2, and a button 3. The housing 1 is provided with a toggle lever moving hole 12, an inner side wall of the toggle lever moving hole 12 is provided with a first protrusion 14. The toggle lever 2 extends into an inner cavity of the housing 1 through the toggle lever moving hole 12, a bottom end of the toggle lever 2 is rotatably connected with the inner cavity of the housing 1, and a top end of the toggle lever 2 protrudes from the toggle lever moving hole 12. The button 3 is slidably arranged inside the toggle lever 2 by means of an elastic component, a side wall of the button 3 is provided with a second protrusion 32, the second protrusion 32 protrudes from a side wall of the toggle lever 2 and can slide inside the toggle lever 2 along with the button 3.

In the above toggle button structure, when the button 3 is not pressed, the second protrusion 32 and the first protrusion 14 are oppositely abutting against each other to effectively prevent the toggle lever 2 from swinging toward a side close to the first protrusion 14, thereby increasing the overall stability of the structure, and preventing occurrence of the toggle lever being pushed accidentally which would result in incorrect operation. And by means of the cooperation of the first protrusion 14 and the second protrusion 32, the stability of the toggle lever 2 at the specific position is ensured and the operation accuracy is improved.

When the button 3 is pressed, the second protrusion 32 moves to a position below the first protrusion 14 and becomes staggered with the first protrusion 14 to enable the toggle lever 2 to swing toward the side close to the first protrusion 14. A user only needs to press the button 3, and then the second protrusion 32 becomes staggered with the first protrusion 14, so as to achieve the swinging of the toggle lever easily, thereby improving the user experience.

It should be noted that, the above-mentioned toggle button structure achieves the unity of stability, reliability and simplicity of operation by means of a clever mechanical design, and is suitable for various occasions requiring precise control and anti-incorrect-operation, not limited to a quick wiring mechanism.

In some embodiments, the side wall of the toggle lever 2 facing the first protrusion 14 is provided with a second protrusion sliding hole 23, the second protrusion 32 passes through the second protrusion sliding hole 23 and can slid along the second protrusion sliding hole 23.

The side wall of the button 3 facing the first protrusion 14 is provided with a first protrusion accommodating groove 33, the first protrusion accommodating groove 33 is located above the second protrusion 32. When the button 3 is pressed and the toggle lever 2 becomes able to swing toward the side close to the first protrusion 14, the first protrusion 14 passes through the second protrusion sliding hole 23 and becomes accommodated in the first protrusion accommodating groove 33.

In this embodiment, when the button 3 is pressed, the first protrusion 14 passes through the second protrusion sliding hole 23 and enters the first protrusion accommodating groove 33, so that a reliable interlocking mechanism is formed to ensure that the toggle lever 2 remains stable at a required position and will not be loosened due to external force or vibration. And after the first protrusion 14 is accommodated in the first protrusion accommodating groove 33, the elastic component exerts an upward press force on the button 3 to generate a press force between the first protrusion 14 and the second protrusion 32, thereby enhancing the interlocking between the second protrusion 14 and the first protrusion 32. The interlocking mechanism enables the toggle lever 2 not to change position easily without the button being pressed again, thereby reducing the risk of incorrect operation.

In this embodiment, the first protrusion 14 is provided with a first-protrusion upper end surface 141, a first-protrusion lower end surface 142 and a first-protrusion side surface 143, the first-protrusion side surface 143 is a surface of the first protrusion facing the second protrusion 32. The second protrusion 32 is provided with a second-protrusion upper end surface 321, a second-protrusion lower end surface 322, and a second-protrusion side surface 323, the second-protrusion side surface 323 is a surface of the second protrusion facing the first protrusion 14. The first protrusion accommodating groove 33 is provided with an accommodating-groove first end surface 331, an accommodating-groove second end surface 332 and an accommodating-groove third end surface 333 connected in sequence, the second-protrusion upper end surface 321 is arranged to be coplanar with the accommodating-groove first end surface 331.

An angle between the accommodating-groove first end surface 331 and the accommodating-groove second end surface 332 is equal to an angle between the first-protrusion lower end surface 142 and the first-protrusion side surface 143, so as to enable the first protrusion 14 to match the first protrusion accommodating groove 33, and thus it ensures that the first protrusion 14 can smoothly enter and become embedded in the first protrusion accommodating groove 33 firmly, while preventing any gap or misalignment. A tight engagement is formed between the first protrusion 14 and the first protrusion accommodating groove 33 by the precise geometric matching, thereby improving the reliability and stability of the locking.

An angle between the accommodating-groove second end surface 332 and the accommodating-groove third end surface 333 is larger than an angle between the first-protrusion upper end surface 141 and the first-protrusion side surface 143, so that when the first protrusion 14 is accommodated in the first protrusion accommodating groove 33, there is a distance between the accommodating-groove third end surface 333 and the first-protrusion upper end surface 141, such that when a user presses the button 3 to make the second-protrusion upper end face 321 and the first-protrusion lower end face 142 no longer squeezed against each other, the toggle lever 2 can be easily pushed at this time, thereby reducing the resistance of operating.

In some embodiments, the first-protrusion side surface 143 and the second-protrusion side surface 323 are both vertical. The design of the vertical surfaces makes the first protrusion 14 and the second protrusion 32 more stable when they are in contact with each other, thereby reducing instability factors caused by a sloping contact surface. The vertical surfaces ensures that contact force is evenly distributed on the contact surface, thereby avoiding any wear or deformation of the first protrusion 14 and/or second protrusion 32 caused by excessive local pressure.

In some embodiments, the first-protrusion lower end surface 142 is a sloping surface gradually sloping downward from an end close to the second protrusion to an end away from the second protrusion. In this embodiment, the design of the sloping lower surface makes the first protrusion 14 able to be guided smoothly when the first protrusion 14 enters the first protrusion accommodating groove 33, thereby reducing the resistance of inserting, so that it can be operated more smoothly. And after the first protrusion 14 is accommodated in the accommodating groove 33, the toggle lever is in an inclined state at this time, and even if a user operates incorrectly by directly pushing the toggle lever in the opposite direction without firstly pressing the button 3, the toggle lever 2 can also be pushed to move (it only needs to overcome the friction between the first-protrusion lower end surface 142 and the second-protrusion upper end face 321), and as compared with a snap-fit connection, even if being operated incorrectly, there would be no damage to parts thereof.

In some embodiments, a side wall of the button 3 is provided with an elongated hole 31, a direction of the major axis of the elongated hole 31 is the same as a movement direction of the button 3 in the toggle lever 2. A position-limiting column 24 is arranged inside the toggle lever 2, and the position-limiting column 24 passes through the elongated hole 31. In this embodiment, the position-limiting column 24 is configured to limit a moving stroke of the button 3 to ensure that the button 3 can only move within a predetermined track, thereby preventing the button 3 from being deviated or stuck during operation. The design of the position-limiting column 24 and the elongated hole 31 makes the button 3 more stable when moving, thus reducing factors of shaking and instability, and improving the reliability and consistency of the operation.

In some embodiments, the toggle lever 2 is divided into a toggle lever rotating part 21 and a button positioning part 22, a bottom end of the toggle lever rotating part 21 is rotatably connected to the housing by a shaft 25, a top end surface of the toggle lever positioning part 13 is provided with a groove, in which the shaft 25 is placed. The toggle lever positioning part 13 supports the shaft 25.

The button positioning part 22 is provided with a button accommodating groove and a spring accommodating groove, the button accommodating groove is respectively communicated with the spring accommodating groove and the second protrusion sliding hole 23, the button is arranged in the button accommodating groove, and part of the button is inserted into the spring accommodating groove.

Elastic component includes a spring 4, one end of the spring 4 is connected to a bottom wall of the spring accommodating groove, and the other end of the spring 4 is connected to a bottom wall of the button 3.

### Embodiment 2

In conjunction with FIGS. 1 to 3, this embodiment discloses a quick wiring mechanism, which includes a toggle button structure and an elastic wire clamping structure.

The housing 1 of the toggle button structure is provided with a wire inserting hole 11 configured for a wire 7 to be inserted therein.

The elastic wire clamping structure is arranged on the housing 1 and has an unlocked state and a locked state; when the elastic wire clamping structure is in the unlocked state, the elastic wire clamping structure provides a reserved space for the wire 7, the reserved space is configured to enable the wire to be inserted into the housing 1 through the wire inserting hole 11; when the elastic wire clamping structure is in the locked state, the elastic wire clamping structure is configured to press the wire 7 that has been inserted into the housing 1 to fasten the wire 7.

A part of the toggle lever 2 of the toggle button structure arranged inside the housing 1 abuts against the elastic wire clamping structure, the toggle lever 2 is configured to control the elastic wire clamping structure to switch between the unlocked state and the locked state.

In the above-mentioned quick wiring mechanism, the operating state of the elastic wire clamping structure is controlled by the toggle lever 2 protruding from the housing, so as to facilitate operation by an operator, and the elastic wire clamping structure is driven to move by the movement of the toggle lever 2, and a wire can be clamped by the elastic wire clamping structure, thus achieving the function of locking the wire. Compared with the conventional method of locking a wire with a screw, the present application does not need to use any wiring tool, an operator only needs to drive the toggle lever 2 to achieve locking of the wire, and ordinary family personnel can perform wiring easily, and therefore the wiring efficiency is improved and labor is saved.

It should be noted that, the housing 1 in this embodiment may be a plug-socket housing, and may also be a housing of other products, the present embodiment may be applied to plug-socket products but is not limited to plug-socket products.

In some embodiments, the elastic wire clamping structure includes an inserted sheet terminal 6 and an elastic-sheet-type wire clamping terminal 5. The inserted sheet terminal 6 is arranged inside the housing 1. The elastic-sheet-type wire clamping terminal 5 is formed by bending and has elasticity, one end of the elastic-sheet-type wire clamping terminal is fixed on the inserted sheet terminal 6, the other end of the elastic-sheet-type wire clamping terminal is configured to fasten the wire 7. The elastic-sheet-type wire clamping terminal 5 has an unlocked state in which the wire can be inserted and a locked state in which the wire is fastened. When the elastic-sheet-type wire clamping terminal 5 is in the unlocked state, the second protrusion 32 and the first protrusion 14 are oppositely abutting against each other, the elastic-sheet-type wire clamping terminal 5 is pressed by the toggle lever 2. When the elastic-sheet-type wire clamping terminal 5 is in the locked state, the toggle lever 2 swings to a side away from the elastic-sheet-type wire clamping terminal 5, and the second protrusion 32 moves to a position below the first protrusion 14 and becomes staggered with the first protrusion 14.

The elastic-sheet-type wire clamping terminal 5 includes a positioning segment 51, a press segment 52 and a clamping segment 53. The positioning segment 51 is connected with the inserted sheet terminal 6. The press segment 52 is connected with the positioning segment 51 and forming an unclosed press ring together with the positioning segment 51, one side of the press ring away from the positioning segment 51 abuts against a side wall of the toggle lever 2, and the press ring has an expanded configuration in an expanded state and a compressed configuration in a compressed state. The clamping segment 53 is connected with the press segment 52 and has a hook shape.

In this embodiment, the clamping segment 53 is arranged to have a hook shape to increase the contact area with a wire, the clamping segment 53 can be pierced into the wire when clamping, which is equivalent to forming a barb in the process of pulling out the wire, thereby improving pull-out resistance for the wire. In fact, the clamping segment 53 may also be arranged to be flat if the clamping force is not taken into consideration. When the toggle lever presses the press ring to the left side, the press ring will be compressed, and the press ring is in a compressed configuration, and thus the clamping segment 53 will be pushed to move toward a side away from the positioning segment 51, and the wire will not be fastened by the clamping segment 53. When the button 3 is pressed, the press ring will expand under elastic force, and the press ring is in expanded configuration at this time, the toggle lever is pushed by the press ring to swing toward the right side, and thus the clamping segment 53 will move and clamp toward a side close to the positioning segment 51 to fasten the wire. It is very convenient to adopt the method in this embodiment to fasten the wire, as it only needs to control the state of the press ring.

The wiring process of a wire in the present application is as follows:

A user inserts a wire 7 into the wire inserting hole 11. When the button is pressed, the cooperation between the first protrusion 14 and the second protrusion 32 is loosened, and at this time, the first protrusion 14 and the second protrusion 32 are no longer abutting against each other, and thus the first protrusion 14 and the second protrusion 32 become staggered. The toggle lever 2 is pushed to move in a direction towards the first protrusion 14, and at this time, the elastic-sheet-type wire clamping terminal 5 will expand to the right to carry the clamping segment 53 to move to the right, the hook of the clamping segment 53 comes into contact with the wire 7, and the clamping segment 53 and the inserted sheet terminal 6 together fasten the wire 7.

The pulling-out process of a wire in the present application is as follows:

A user presses down the button 3 (this operation may also not be performed), and then pushes the toggle lever in the opposite direction to reset the elastic-sheet-type wire clamping terminal, and at this time, the clamping segment 53 moves in a direction away from the wire 7 to be disengaged from the wire 7. A spring 4 arranged inside the toggle lever 2 pushes the button 3 to move upward due to the elastic force thereof, and when the toggle lever 2 swings to a vertical position, the second protrusion 32 on the button 3 becomes abutting against the first protrusion 14 on the housing, and then the elastic-sheet-type wire clamping terminal is unlocked, the wire is not clamped in the reserved space, and can be pulled out easily.

Explanation of how to prevent an incorrect operation: after a user insert a wire 7 into the wire inserting hole 11, if the user operates incorrectly to push the toggle lever 2, because the second protrusion on the button is completely abutting against the first protrusion on the housing, the user cannot push the toggle lever 2 to move, and can only press the button 3 firstly, so as to prevent the user from operating incorrectly, and make the structure more secure and reliable.

### Embodiment 3

A specific embodiment of a quick wiring mechanism as shown in FIG. 4 to FIG. 7, the quick wiring mechanism includes a housing 1, an elastic wire clamping structure and a toggle structure 8. The housing 1 is provided with at least one wire inserting hole 11 configured for a wire 7 to be inserted therein. There is at least one elastic wire clamping structure, which is arranged on the housing 1 and has an unlocked state and a locked state. When the elastic wire clamping structure is in the unlocked state, the elastic wire clamping structure provides a reserved space for the wire 7, the reserved space is configured to enable the wire to be inserted into the housing 1 through the wire inserting hole 11; when the elastic wire clamping structure is in the locked state, the elastic wire clamping structure is configured to press the wire 7 that has been inserted into the housing 1 to fasten the wire 7. A part of the toggle structure is arranged inside the housing 1 and configured to abut against the elastic wire clamping structure, another part of the toggle structure protrudes from the housing 1, the toggle structure is configured to control the elastic wire clamping structure to switch between the unlocked state and the locked state.

The above-mentioned quick wiring mechanism, the operating state of the elastic wire clamping structure is controlled by the toggle structure 8 protruding from the housing, so as to facilitate operation by an operator, and the elastic wire clamping structure is driven to move by the movement of the toggle structure 8, and a wire can be clamped by the elastic wire clamping structure, thus achieving the function of locking the wire. Compared with the conventional method of locking a wire with a screw, the present application does not need to use any wiring tool, an operator only needs to drive the toggle structure 8 to achieve locking of the wire, and ordinary family personnel can perform wiring easily, and therefore the wiring efficiency is improved and labor is saved.

It should be noted that, the housing 1 in this embodiment may be a plug-socket housing, and may also be a housing of other products, the present embodiment may be applied to plug-socket products but is not limited to plug-socket products.

In some embodiments, the housing 1 is provided with a toggle lever moving hole 12, a toggle lever positioning part 13 and a hook positioning part 15, there are at least one toggle lever moving hole 12, at least one toggle lever positioning part 13 and at least one hook positioning part 15, respectively. In this embodiment, the toggle lever moving hole 12 is configured to enable a top part of the toggle structure 8 to protrude from the housing 1, and provide a space for the swinging of the toggle structure 8. The toggle lever positioning part 13 is arranged inside the housing 1, the toggle lever positioning part 13 is configured to position a bottom end of the toggle structure 8 to enable the bottom end of the toggle structure 8 to be positioned inside the housing 1. The hook positioning part 15 (bottom housing snap-fit part) is configured to be engaged with or be disengaged from the toggle structure 8, so as to control the elastic wire clamping structure to be in the unlocked state or in the locked state.

In some embodiments, the toggle structure 8 includes a toggle lever 2 and an engaging member. A bottom end of the toggle lever 2 is rotatably connected to the toggle lever positioning part 13 by a shaft 25, a top end of the toggle lever 2 protrudes from the toggle lever moving hole 12. An outer diameter of the toggle lever 2 is smaller than an inner diameter of the toggle lever moving hole 12, so as to ensure that when the toggle lever 2 pivots around the toggle lever positioning part 13, the top part of the toggle lever 2 can swing normally. The engaging member is arranged on the toggle lever 2 and has an engaged state of being engaged with the hook positioning part 15 and a disengaged state of being disengaged from the hook positioning part 15.

In this embodiment, when the engaging member is in the disengaged state, the engaging member is not engaged with the hook positioning part 15, and at this time, the toggle lever 2 pivots under elastic force of the elastic wire clamping structure, more specifically, the bottom end of the toggle lever 2 pivots around the shaft 25, and the top part of the toggle lever 2 swings, and at this time, the elastic wire clamping structure is in the locked state. When the engaging member is in the engaged state, the toggle lever 2 is extending in a vertical direction, the toggle lever 2 exerts a press force on the elastic wire clamping structure in the left direction, and at this time the elastic wire clamping structure is in the unlocked state, and the wire can be inserted into the interior of the housing normally.

In some embodiments, the elastic wire clamping structure includes an inserted sheet terminal 6 and an elastic-sheet-type wire clamping terminal 5. The inserted sheet terminal 6 is arranged inside the housing 1. The elastic-sheet-type wire clamping terminal 5 is formed by bending and has elasticity, one end of the elastic-sheet-type wire clamping terminal is fixed on the inserted sheet terminal 6, the other end of the elastic-sheet-type wire clamping terminal is configured to fasten the wire.

In this embodiment, the elastic-sheet-type wire clamping terminal 5 has an unlocked state in which the wire can be inserted and a locked state in which the wire is fastened. When the elastic-sheet-type wire clamping terminal 5 is in the unlocked state, the engaging member is in the engaged state, and the elastic-sheet-type wire clamping terminal 5 is pressed by the toggle lever 2 to the left side, and at this time, the wire will not be clamped by the elastic-sheet-type wire clamping terminal 5; when the elastic-sheet-type wire clamping terminal 5 is in the locked state, the engaging member is in the disengaged state, and the toggle lever 2 rotates to a side away from the inserted sheet terminal 6, and at this time, the wire is clamped by the elastic-sheet-type wire clamping terminal 5 to achieve the locking function.

In some embodiments, the elastic-sheet-type wire clamping terminal 5 includes a positioning segment 51, a press segment 52 and a clamping segment 53. The positioning segment 51 is connected with the inserted sheet terminal 6. The press segment 52 is connected with the positioning segment 51 and forming an unclosed press ring together with the positioning segment 51, one side of the press ring away from the positioning segment 51 abuts against a side wall of the toggle lever 2, and the press ring has an expanded configuration in an expanded state and a compressed configuration in a compressed state. The clamping segment 53 is connected with the press segment 52 and has a hook shape.

In this embodiment, the clamping segment 53 is arranged to have a hook shape to increase the contact area with a wire, the clamping segment 53 can be pierced into the wire when clamping, which is equivalent to forming a barb in the process of pulling out the wire, thereby improving pull-out resistance for the wire. In fact, the clamping segment 53 may also be arranged to be flat if the clamping force is not taken into consideration. When the toggle lever presses the press ring to the left side, the press ring will be compressed, and at this time the press ring is in a compressed configuration, and thus the clamping segment 53 will be pushed to move toward a side away from the positioning segment 51, and the wire will not be fastened by the clamping segment 53. When the engaging member is not engaged with the hook positioning part 15, the press will expand under elastic force, and at this time the press ring is in the expanded configuration, the toggle lever 2 is pushed by the press ring to swing toward the right side, and thus the clamping segment 53 will move and clamp toward a side close to the positioning segment 51 to fasten the wire. It is very convenient to adopt the method in this embodiment to fasten the wire, as it only needs to control the state of the press ring.

In some embodiments, the toggle lever 2 includes a toggle lever rotating part 21 and a button positioning part 22. A bottom end of the toggle lever rotating part 21 is rotatably connected to the toggle lever positioning part 13 by a shaft 25. A side wall of the toggle lever rotating part 21 abutting against the elastic-sheet-type wire clamping terminal 5 is a sloping side wall that slopes from top to bottom in a direction away from the elastic-sheet-type wire clamping terminal 5, so that when the toggle lever swings, the elastic wire clamping structure can be smoothly expanded to enable the clamping segment 53 of the elastic wire clamping structure to move in a direction towards the wire to fasten the wire. The button positioning part 22 is integrally connected with the toggle lever rotating part 21, and a part of the button positioning part 22 protrudes from the toggle lever moving hole 12.

In some embodiments, the toggle lever positioning part 13 includes a protrusion part on the bottom housing and a side wall of the top housing, a bottom part of the toggle lever rotating part 21 is rotatably connected to the side wall of the top housing through a shaft 25, a top end surface of the protrusion part on the bottom housing is provided with a groove, in which the shaft 25 is placed. The protrusion part on the bottom housing supports the shaft 25.

In some embodiments, an engaging-member accommodating cavity configured to position the engaging member is provided inside the button positioning part 22, and a side wall of the button positioning part 22 is provided with a hook sliding hole 85 communicated with the engaging-member accommodating cavity.

In this embodiment, an engaging-member accommodating cavity configured to position the engaging member is provided inside the button positioning part 22, so as to facilitate accommodating the engaging member, and the hook sliding hole 85 is provided to facilitate the engaging member sliding up and down.

In some embodiments, the engaging member includes a button 3, a spring positioning column 82, a spring 4 and a hook 81. The button 3 is arranged inside the engaging-member accommodating cavity, and a top end of the button protrudes from the button positioning part 22. The spring positioning column 82 is integrally arranged at a bottom end of the button 3 at a distance from an inner bottom wall of the engaging-member accommodating cavity. The spring 4 is sleeved on the spring positioning column 82, one end of the spring is fixed to a bottom wall of the button 3, and the other end of the spring is fixed to the inner bottom wall of the engaging-member accommodating cavity. The hook 81 is integrally connected with the button 3 and protrudes from the button positioning part 22 through the hook sliding hole 85, the hook 81 is configured to be engaged with the hook positioning part 15 or be disengaged from the hook positioning part 15.

In this embodiment, when the button 3 is pressed downwardly, the button 3 will compress the spring 4 downwardly, and at this time the hook 81 can become disengaged from the hook positioning part 15 to achieve the swinging of the toggle lever. This embodiment realizes controlling of the engaged and disengaged state of the toggle structure 8 by controlling the button 3 that protrudes out of the housing, so as to control the operating state of the elastic clamping structure, which is very convenient and fast to operate, thereby realizing the purpose of quick wiring.

In some embodiments, as shown in FIG. 6, a side wall of the button positioning part 22 is further provided with a convex block sliding hole 84, the convex block sliding hole 84 is arranged in an opposite side relative to the hook sliding hole 85; a convex block 83 configured to slide in the convex block sliding hole 84 is integrally connected to the button 3, the convex block 83 provides an abutting position for the spring 4; and a convex block abutting part 16 configured to provide an abutting position for the convex block 83 is arranged inside the housing 1.

In this embodiment, the convex block can slide in the convex block sliding hole 84 steadily, which guides the button 3 to slide up and down, and ensures the sliding stability of the button 3.

In some embodiments, a side wall of the inserted sheet terminal 6 is provided with at least one convex rib configured for clamping the wire, and the convex rib has a barb shape.

In this embodiment, the convex rib is arranged to extend on the inserted sheet terminal 6, thereby achieving the purpose of clamping the wire firmly and further reinforcing the function of locking the wire.

In the present application, a user can insert and pull out a wire easily without using any tool, so as to reduce the time spent by the user for wiring, and to improve the wiring efficiency.

The process of wiring and pulling out a wire in the present application is as follows:

After a quick wiring mechanism of the present application is sold (the state of products during delivery from a factory to a user), the clamping segment 53 and the hook 81 are in the engaged state, a distance between the clamping segment 53 and the inserted sheet terminal 6 is large, and thus when a wire 7 is inserted into the housing, the wire will not be locked by the hook of the clamping segment 53. The toggle lever 2 interferes with the tendency of the elastic-sheet-type wire clamping terminal 5 moving to the right, and thus the press ring is in the compressed configuration, that is, the elastic-sheet-type wire clamping terminal is in a state of being compressed to the left.

As shown in FIG. 4, a reserved space configured to facilitate a wire being inserted is provided between the clamping segment 53 of the elastic-sheet-type wire clamping terminal 5 and the inserted sheet terminal 6, and thereby a wire 7 can be easily inserted into the housing through the wire inserting hole 11, and the wire 7 comes into contact with the inserted sheet terminal 6 inside the housing.

As shown in FIG. 5, after an operator inserts a wire, he/she presses the button 3 downwardly, the engagement is loosened, and then the toggle lever 2 rotates to the right around the shaft at the bottom thereof under the elastic force of the elastic-sheet-type wire clamping terminal 5, wherein the elastic-sheet-type wire clamping terminal 5 expand to the right at this time to carry the clamping segment 53 to move to the right, the hook of the clamping segment 53 comes into contact with the wire 7, and the clamping segment 53 and the inserted sheet terminal 6 work together to lock the wire 7 in place.

When pulling out a wire, the toggle lever is pushed to become engaged with the hook positioning part, as shown in FIG. 5 and FIG. 7, the hook 81 is provided with a sloping surface corresponding to a sloping surface on the hook positioning part, so that when pushing the toggle lever 2, the hook 81 can become hooked and engaged with the hook positioning part smoothly. The elastic-sheet-type wire clamping terminal is reset, and then the elastic-sheet-type wire clamping terminal becomes unlocked, so that the wire can be pulled out quickly.

Apparently, the above embodiments are merely examples for clear illustration, and not intended to limit to the implementing ways. For a person with ordinary skill in the art, various changes or modifications in different forms can also be made based on the above description. It is neither necessary nor possible to exhaustively enumerate all the embodiments herein. Any obvious changes or modifications that may arise from this are still within the scope of protection of the present application.

1. A toggle button structure, comprising:
a housing (1), wherein the housing (1) is provided with a toggle lever moving hole (12), an inner side wall of the toggle lever moving hole (12) is provided with a first protrusion (14);
a toggle lever (2), wherein the toggle lever (2) extends into an inner cavity of the housing (1) through the toggle lever moving hole (12), a bottom end of the toggle lever (2) is rotatably connected with the inner cavity of the housing (1), and a top end of the toggle lever (2) protrudes from the toggle lever moving hole (12);
a button (3), wherein the button (3) is slidably arranged inside the toggle lever (2) by means of an elastic component, a side wall of the button (3) is provided with a second protrusion (32), the second protrusion (32) protrudes from a side wall of the toggle lever (2) and can slide inside the toggle lever (2) along with the button (3);
wherein, when the button (3) is not pressed, the second protrusion (32) and the first protrusion (14) are oppositely abutting against each other to prevent the toggle lever (2) from swinging toward a side close to the first protrusion (14); when the button (3) is pressed, the second protrusion (32) moves to a position below the first protrusion (14) and becomes staggered with the first protrusion (14) to enable the toggle lever (2) to swing toward the side close to the first protrusion (14).

2. The toggle button structure according to claim 1, wherein the side wall of the toggle lever (2) facing the first protrusion (14) is provided with a second protrusion sliding hole (23), the second protrusion (32) passes through the second protrusion sliding hole (23) and can slid along the second protrusion sliding hole (23).

3. The toggle button structure according to claim 2, wherein the side wall of the button (3) facing the first protrusion (14) is provided with a first protrusion accommodating groove (33), the first protrusion accommodating groove (33) is located above the second protrusion (32);
when the button (3) is pressed to enable the toggle lever (2) to swing toward the side close to the first protrusion (14), the first protrusion (14) passes through the second protrusion sliding hole (23) and becomes accommodated in the first protrusion accommodating groove (33).

4. The toggle button structure according to claim 3, wherein the first protrusion (14) is provided with a first-protrusion upper end surface (141), a first-protrusion lower end surface (142) and a first-protrusion side surface (143), the first-protrusion side surface (143) is a surface of the first protrusion facing the second protrusion (32);
the second protrusion (32) is provided with a second-protrusion upper end surface (321), a second-protrusion lower end surface (322), and a second-protrusion side surface (323), the second-protrusion side surface (323) is a surface of the second protrusion facing the first protrusion (14);
the first protrusion accommodating groove (33) is provided with an accommodating-groove first end surface (331), an accommodating-groove second end surface (332) and an accommodating-groove third end surface (333) connected in sequence, the second-protrusion upper end surface (321) is arranged to be coplanar with the accommodating-groove first end surface (331);
an angle between the accommodating-groove first end surface (331) and the accommodating-groove second end surface (332) is equal to an angle between the first-protrusion lower end surface (142) and the first-protrusion side surface (143), so as to enable the first protrusion (14) to match the first protrusion accommodating groove (33).

5. The toggle button structure according to claim 4, wherein an angle between the accommodating-groove second end surface (332) and the accommodating-groove third end surface (333) is larger than an angle between the first-protrusion upper end surface (141) and the first-protrusion side surface (143), so that when the first protrusion (14) is accommodated in the first protrusion accommodating groove (33), there is a distance between the accommodating-groove third end surface (333) and the first-protrusion upper end surface (141).

6. The toggle button structure according to claim 4, wherein the first-protrusion side surface (143) and the second-protrusion side surface (323) are both vertical.

7. The toggle button structure according to claim 4, wherein the first-protrusion lower end surface (142) is a sloping surface gradually sloping downward from an end close to the second protrusion to an end away from the second protrusion.

8. The toggle button structure according to claim 1, wherein a side wall of the button (3) is provided with an elongated hole (31), a direction of the major axis of the elongated hole (31) is the same as a movement direction of the button (3) in the toggle lever (2); a position-limiting column (24) is arranged inside the toggle lever (2), the position-limiting column (24) passes through the elongated hole (31) and is configured to limit a moving stroke of the button (3).

9. A quick wiring mechanism, comprising:
the toggle button structure of claim 1, wherein the housing (1) of the toggle button structure is provided with a wire inserting hole (11) configured for a wire (7) to be inserted therein;
an elastic wire clamping structure, which is arranged on the housing (1) and has an unlocked state and a locked state; wherein, when the elastic wire clamping structure is in the unlocked state, the elastic wire clamping structure provides a reserved space for the wire (7), the reserved space is configured to enable the wire to be inserted into the housing (1) through the wire inserting hole (11); when the elastic wire clamping structure is in the locked state, the elastic wire clamping structure is configured to press the wire (7) that has been inserted into the housing (1) to fasten the wire (7);
wherein a part of the toggle lever (2) of the toggle button structure arranged inside the housing (1) abuts against the elastic wire clamping structure, the toggle lever (2) is configured to control the elastic wire clamping structure to switch between the unlocked state and the locked state.

10. The quick wiring mechanism according to claim 9, wherein the elastic wire clamping structure comprises:
an inserted sheet terminal (6), arranged inside the housing (1);
an elastic-sheet-type wire clamping terminal (5), which is formed by bending and has elasticity, wherein one end of the elastic-sheet-type wire clamping terminal is fixed on the inserted sheet terminal (6), the other end of the elastic-sheet-type wire clamping terminal is configured to fasten the wire (7); the elastic-sheet-type wire clamping terminal (5) has an unlocked state in which the wire can be inserted and a locked state in which the wire is fastened;
when the elastic-sheet-type wire clamping terminal (5) is in the unlocked state, the second protrusion (32) and the first protrusion (14) are oppositely abutting against each other, and the elastic-sheet-type wire clamping terminal (5) is pressed by the toggle lever (2); when the elastic-sheet-type wire clamping terminal (5) is in the locked state, the toggle lever (2) swings to a side away from the elastic-sheet-type wire clamping terminal (5), and the second protrusion (32) moves to a position below the first protrusion (14) and becomes staggered with the first protrusion (14).

11. A quick wiring mechanism, comprising:
a housing (1), provided with at least one wire inserting hole (11) configured for a wire (7) to be inserted therein;
at least one elastic wire clamping structure, which is arranged on the housing (1) and has an unlocked state and a locked state; wherein, when the elastic wire clamping structure is in the unlocked state, the elastic wire clamping structure provides a reserved space for the wire (7), the reserved space is configured to enable the wire to be inserted into the housing (1) through the wire inserting hole (11); when the elastic wire clamping structure is in the locked state, the elastic wire clamping structure is configured to press the wire (7) that has been inserted into the housing (1) to fasten the wire (7);
a toggle structure (8), wherein a part of the toggle structure is arranged inside the housing (1) and configured to abut against the elastic wire clamping structure, another part of the toggle structure protrudes from the housing (1), the toggle structure is configured to control the elastic wire clamping structure to switch between the unlocked state and the locked state.

12. The quick wiring mechanism according to claim 11, wherein the housing (1) is provided with:
at least one toggle lever moving hole (12), configured to enable a top part of the toggle structure (8) to protrude from the housing (1);
at least one toggle lever positioning part (13), configured to position a bottom end of the toggle structure (8);
at least one hook positioning part (15), configured to be engaged with or be disengaged from the toggle structure (8), so as to control the elastic wire clamping structure to be in the unlocked state or in the locked state.

13. The quick wiring mechanism according to claim 12, wherein the toggle structure (8) comprises:
a toggle lever (2), wherein a bottom end of the toggle lever is rotatably connected to the toggle lever positioning part (13), a top end of the toggle lever protrudes from the toggle lever moving hole (12); an outer diameter of the toggle lever (2) is smaller than an inner diameter of the toggle lever moving hole (12);
an engaging member, which is arranged on the toggle lever (2) and has an engaged state of being engaged with the hook positioning part (15) and a disengaged state of being disengaged from the hook positioning part (15).

14. The quick wiring mechanism according to claim 13, wherein the elastic wire clamping structure comprises:
an inserted sheet terminal (6), arranged inside the housing (1);
an elastic-sheet-type wire clamping terminal (5), which is formed by bending and has elasticity, wherein one end of the elastic-sheet-type wire clamping terminal is fixed on the inserted sheet terminal (6), the other end of the elastic-sheet-type wire clamping terminal is configured to fasten the wire (7); the elastic-sheet-type wire clamping terminal (5) has an unlocked state in which the wire can be inserted and a locked state in which the wire is fastened;
when the elastic-sheet-type wire clamping terminal (5) is in the unlocked state, the engaging member is in the engaged state, and the elastic-sheet-type wire clamping terminal (5) is pressed by the toggle lever (2); when the elastic-sheet-type wire clamping terminal (5) is in the locked state, the engaging member is in the disengaged state, and the toggle lever (2) is rotated to a side away from the inserted sheet terminal (6).

15. The quick wiring mechanism according to claim 14, wherein the elastic-sheet-type wire clamping terminal (5) comprises:
a positioning segment (51), connected with the inserted sheet terminal (6);
a press segment (52), connected with the positioning segment (51) and forming an unclosed press ring together with the positioning segment (51), wherein one side of the press ring away from the positioning segment (51) abuts against a side wall of the toggle lever (2), and the press ring has an expanded configuration in an expanded state and a compressed configuration in a compressed state;
a clamping segment (53), connected with the press segment (52) and having a hook shape.

16. The quick wiring mechanism according to claim 14, wherein the toggle lever (2) comprises:
a toggle lever rotating part (21), wherein a bottom end of the toggle lever rotating part is rotatably connected to the toggle lever positioning part (13); a side wall of the toggle lever rotating part (21) abutting against the elastic-sheet-type wire clamping terminal (5) is a sloping side wall that slopes from top to bottom in a direction away from the elastic-sheet-type wire clamping terminal (5);
a button positioning part (22), integrally connected with the toggle lever rotating part (21), and partially protruding from the toggle lever moving hole (12).

17. The quick wiring mechanism according to claim 16, wherein an engaging-member accommodating cavity configured to position the engaging member is provided inside the button positioning part (22), and a side wall of the button positioning part (22) is provided with a hook sliding hole (85) communicated with the engaging-member accommodating cavity.

18. The quick wiring mechanism according to claim 17, wherein the engaging member comprises:
a button (3), arranged inside the engaging-member accommodating cavity, wherein a top end of the button protrudes from the button positioning part (22);
a spring positioning column (82), integrally arranged at a bottom end of the button (3) at a distance from an inner bottom wall of the engaging-member accommodating cavity;
a spring (4), sleeved on the spring positioning column (82), wherein one end of the spring is fixed to a bottom wall of the button (3), and the other end of the spring is fixed to the inner bottom wall of the engaging-member accommodating cavity;
a hook (81), integrally connected with the button (3), and protruding from the button positioning part (22) through the hook sliding hole (85), wherein the hook (81) is configured to be engaged with the hook positioning part (15) or be disengaged from the hook positioning part (15).

19. The quick wiring mechanism according to claim 18, wherein a side wall of the button positioning part (22) is further provided with a convex block sliding hole (84), the convex block sliding hole (84) is arranged in an opposite side relative to the hook sliding hole (85); a convex block (83) configured to slide in the convex block sliding hole (84) is integrally connected to the button (3); and a convex block abutting part (16) configured to provide an abutting position for the convex block (83) is arranged inside the housing (1).

20. The quick wiring mechanism according to claim 14, wherein a side wall of the inserted sheet terminal (6) is provided with at least one convex rib configured for clamping the wire, and the convex rib has a barb shape.
